(19) United States
(12) Patent Application Publication
(10) Pub. No.: US 2025/0092715 A1
(43) Pub. Date: Mar. 20, 2025

(54) SPEAKER STRUCTURE

(71) Applicant: Tymphany HK Limited, Hong Kong (HK)

(72) Inventors: YIKAI GUO, Taipei City (TW); TIANBAO XIE, Taipei City (TW); KAIJIU TAN, Taipei City (TW)

(21) Appl. No.: 18/886,603

(22) Filed: Sep. 16, 2024

Related U.S. Application Data
(60) Provisional application No. 63/583,681, filed on Sep. 19, 2023.

(51) Int. Cl. E05B 15/10; B60R 11/02; H04R 1/02

(52) U.S. Cl. CPC E05B 15/101; B60R 11/0217; H04R 1/025; H04R 1/028; H04R 2499/13

(57) ABSTRACT

A speaker structure includes a speaker and a base. The base has a case and a locking assembly. The surface of the case has an accommodating groove. The speaker is configured to be installed within the accommodating groove. A lock housing is disposed within the case. The lock unit extends through the lock housing. One end of the lock unit connects to the speaker. One end of the lock elastic element connects to the lock housing, another end of the lock elastic element connects to another end of the lock unit. One end of the lock pin extends through the lock housing, and one end of the lock pin engage with a side of the lock unit. Wherein one end of the lock pin is away from a side of the lock unit, one end of the lock unit unlocks the connection relative to the speaker.

### CROSS REFERENCE TO RELATED APPLICATION

This application claims priority of U.S. Provisional Application No. 63/583,681 filed on Sep. 19, 2023 under 35 U.S.C. § 119(e), the entire contents of which are hereby incorporated by reference

### BACKGROUND OF THE INVENTION

The present application relates to the technical field of speaker structures, and more particularly to a detachable speaker structure.

### DESCRIPTION OF THE RELATED ART

Currently, the design of vehicle-mounted speaker structures typically involves securing them inside the vehicle body. If the speaker becomes damaged, it usually needs to be removed from the vehicle for repair or replacement. However, removing the speaker requires not only specialized disassembly tools but also a complex disassembly process. As a result, it is generally difficult for ordinary users to perform the disassembly themselves. Even professional technicians may find the process time-consuming.

### SUMMARY OF THE INVENTION

The present application provides a speaker structure that, through the design of a locking assembly, can simply assemble or disassemble the speaker to the base to solve the problem that the speaker is inconvenient to assemble and disassemble.

To address the above technical problem, the present application is implemented as follows.

The present application provides a speaker structure including a speaker and a base. The speaker has a fixing assembly. The base has a case and a locking assembly. A surface of the case has an accommodating groove, the speaker is installed within the accommodating groove. The locking assembly includes a lock housing, a lock unit, a lock elastic element, a lock pin and a lock pin elastic element. The lock housing is disposed within the case, the lock unit extends through the lock housing. One end of the lock unit extends through the case into the accommodating groove, and one end of the lock unit connects to the fixing assembly fixed to the speaker. One end of the lock elastic element connects to the lock housing and another end of the lock elastic element connects to another end of the lock unit. One end of the lock pin extends through the lock housing and one end of the lock pin engages with a side of the lock unit. One end of the lock pin elastic element connects to the lock housing and another end of the lock pin elastic element connects to another end of the lock pin. The lock pin elastic element drives the lock pin to abut against a side of the lock unit; wherein one end of the lock pin moves away from a side of the lock unit, the lock pin does not engage with a side of the lock unit, the lock elastic element drives the lock unit to move, for releasing a connection between one end of the lock unit relative to the fixing assembly of the speaker.

According to one embodiment of the present application, the locking assembly further includes a first guide member, the lock housing includes a lock pin channel. The first guide member extends through the lock housing and the first guide member locates within the lock pin channel. The lock unit further includes a moving element and a hook element, the hook element is rotatably disposed at one end of the moving element, the first guide member is located on a movement path of a first side of the hook element. When the moving element moves in conjunction with the hook element, the first guide member moves along a contour of the first side of the hook element, causing the hook element to rotate relative to the moving element.

According to one embodiment of the present application, one end of the moving element has a first concave, the hook element has a second concave at the end corresponding to the first concave. The second concave rotates relative to the first concave to become closed or open, wherein the first side of the hook element has an arc edge and a first concave edge, the first concave edge and the arc edge are connected and extended side edges. When the arc edge of the hook element abuts against the first guide member, the first concave and the second concave are relative closed; when the first concave edge of the hook element abuts against the first guide member, the first concave and the second concave are relative open.

According to one embodiment of the present application, the locking assembly further includes a second guide member, the lock housing includes a lock pin channel. The second guide member extends through the lock housing and the second guide member locates within the lock pin channel. The lock unit further includes a moving element and a hook element, the hook element is rotatably disposed at one end of the moving element, the moving element further has a moving hole, the second guide member locates within the moving hole, and the second guide member locates on a movement path of a second side of the hook element. When the moving element moves in conjunction with the hook element, the second guide member moves along a contour of the second side of the hook element, causing the hook element to rotate relative to the moving element.

According to one embodiment of the present application, one end of the moving element has a first concave, the hook element has a second concave, locating at one end of the hook element corresponding to the first concave. The second concave rotates relative to the first concave to become closed or open, wherein the second side of the hook element has an inclined edge and a second concave edge, the second concave edge and the inclined edge are connected and extended side edges. When the second concave edge of the hook element abuts against the second guide member, the first concave and the second concave are relative closed; When the inclined edge of the hook element abuts against the second guide member, the first concave and the second concave are relative open.

According to one embodiment of the present application, the locking assembly further includes a position limiting element, the position limiting element is disposed in the lock housing, and the position limiting element locates in the lock pin channel. The lock unit further includes a moving element. The moving element further has a position limiting hole and the position limiting element locates within the position limiting hole.

According to one embodiment of the present application, the lock housing includes a lock pin channel and a fixed through hole, the fixed through hole locates on the surface of the lock housing. The fixed through hole and the lock pin channel are communicating with each other and the lock unit further includes a moving element. One side of the moving element has a fixed notch, the fixed through hole locates on the movement path of the fixed notch of the moving element, one end of the lock pin passes through the fixed through hole, one end of the lock pin is embedded within the fixed notch, thus one end of the lock pin is engaged with one end of the lock unit.

According to one embodiment of the present application, an elastic force direction of the lock elastic element and a movement direction of the lock unit is a first axis. An elastic force direction of the lock pin elastic element and a movement direction of the lock pin is a second axis, and the first axis and the second axis are perpendicular to each other.

According to one embodiment of the present application, the base further includes a press assembly and a connecting assembly, the connecting assembly is disposed within the case. One end of the press assembly passes through the case and one end of the press assembly moves in conjunction with the connecting assembly, the connecting assembly moves in conjunction with another end of the lock pin.

According to one embodiment of the present application, the connecting assembly further includes a connection main body, the connection main body of the connecting assembly further has a pressing element, the pressing element corresponds to another end of the lock pin of the locking assembly. When the press assembly moves in conjunction with the pressing element of the connection main body, the pressing element moves in conjunction with another end of the lock pin for allowing one end of the lock pin to move away from a side of the lock unit.

According to one embodiment of the present application, the connecting assembly further has a connecting elastic portion, the connection main body of the connecting assembly further has an elastic fixing portion. One end of the connecting elastic portion connects to the elastic fixing portion and another end of the connecting elastic portion connects to the inner portion of the case. An elastic force direction of the connecting elastic portion and a direction that the pressing element of the connection main body moves in conjunction with the lock pin is second axis.

According to one embodiment of the present application, the fixing assembly has a recess and a stationary post. Two ends of the stationary post are fixed to a recess inner wall of the recess. One end of the lock unit is fixed to the stationary post within the recess.

The present application provides a speaker structure includes a speaker and a base. The speaker is fixed to the base. The base fixes or unlocks the speaker through the linkage of the press assembly, the connecting assembly, and the locking assembly. The locking assembly of the base is applied for fixing the speaker. By using the press assembly to interact with the connecting assembly, the connecting assembly unlocks the speaker fixed by the locking assembly. Thus, the speaker can be easily removed from the base without spending too much time.

### BRIEF DESCRIPTION OF DRAWINGS

The accompanying drawings described here are provided to further understand the present invention and constitute a part of the present invention. The illustrative embodiments and descriptions of the present invention are intended to explain the present invention and do not constitute undue limitations to the present invention. In the drawings:

FIG. 1 is a perspective view of the speaker structure of the present application;

FIG. 2 is an exploded view of the speaker structure of the present application;

FIG. 3 is an exploded assembly view of the speaker structure of the present application;

FIG. 4 is a partial perspective view of the speaker structure of the present application;

FIG. 5 is a combination view of the press assembly, the connecting assembly and the locking assembly of the present application;

FIG. 6 is a partial exploded view of the press assembly, the connecting assembly and the locking assembly of the present application;

FIG. 7 is a side view of the press assembly, the connecting assembly and the locking assembly of the present application;

FIG. 8 is a schematic view of the locking assembly of the present application;

FIG. 9 is a cross-sectional view of the locking assembly of the present application;

FIG. 10 is a schematic view of the combination of the locking assembly and the speaker of the present application; and

FIG. 11 is another schematic view of the combination of the locking assembly and the speaker of the present application.

### DETAILED DESCRIPTION

The following will disclose multiple embodiments of the present invention with reference to the drawings. For the sake of clear explanation, many implementation details will be described together in the following narrative. However, it should be understood that these implementation details should not be used to limit the present invention. In other words, in some embodiments of the present invention, these implementation details are not necessary. Additionally, for the sake of simplifying the drawings, some conventional structures and components will be depicted in a simplified schematic manner. In the following embodiments, the same reference numerals will be used to denote the same or similar components.

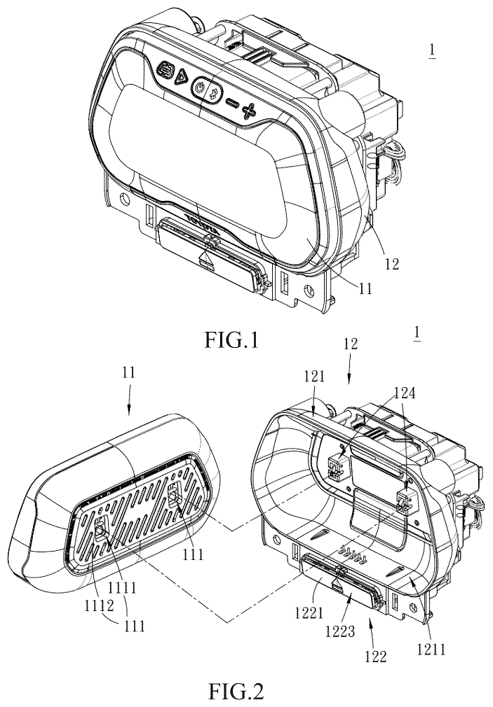

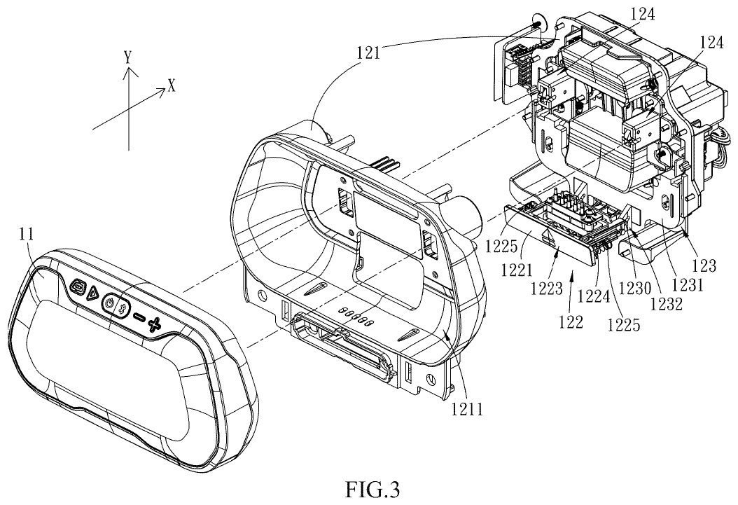

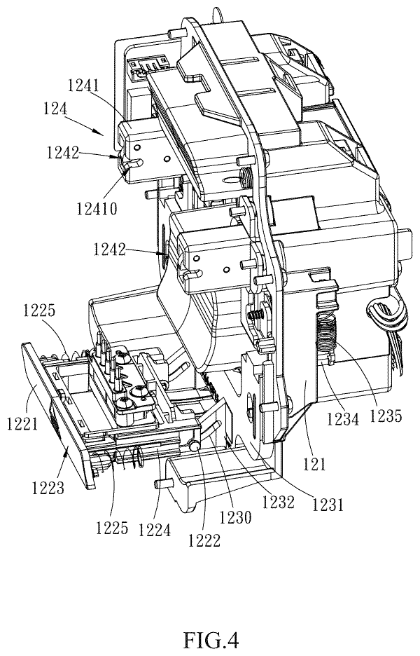

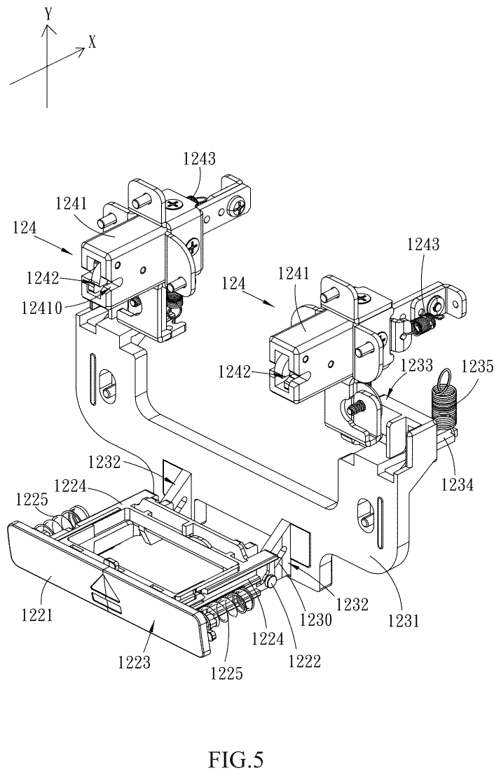

FIG. 1 is a perspective view of the speaker structure of the present application; FIG. 2 is an exploded view of the speaker structure of the present application; FIG. 3 is an exploded assembly view of the speaker structure of the present application; FIG. 4 is a partial perspective view of the speaker structure of the present application; and FIG. 5 is a combination view of the press assembly, the connecting assembly and the locking assembly of the present application. As shown in FIG. 1 to FIG. 5, the present application provides a speaker structure 1 including a speaker 11 and a base 12. The speaker 11 has a fixing assembly 111. The base 12 has a case 121, a press assembly 122, a connecting assembly 123 and a locking assembly 124. A surface of the case 121 has an accommodating groove 1211. The speaker 11 is installed within the accommodating groove 1211. The connecting assembly 123 and the locking assembly 124 are disposed within the case 121. One end of the press assembly 122 extends through into the case 121 and one end of the press assembly 122 moves in conjunction with the connecting assembly 123. The connecting assembly 123 is applied to unlock the locking assembly 124. One end of the locking assembly 124 extends through the case 121 into the accommodating groove 1211. One end of the locking assembly 124 is connected and fixed to the fixing assembly 111. One end of the press assembly 122 is pushed into the case 121, the press assembly 122 moves in conjunction with the connecting assembly 123 to unlock the locking assembly 124, such that the locking assembly 124 is released from the connection with the fixing assembly 111 of the speaker 11.

Referring to FIG. 2, in this embodiment, the groove contour of the accommodating groove 1211 of the base 12 corresponds to the contour of the side of the speaker 11 with the fixing assembly 111. The fixing assembly 111 has a recess 1111 and a stationary post 1112. Two ends of the stationary post 1112 are fixed to the inner wall of the recess 1111. One end of the locking assembly 124 is fixed to the stationary post 1112 within the recess 1111.

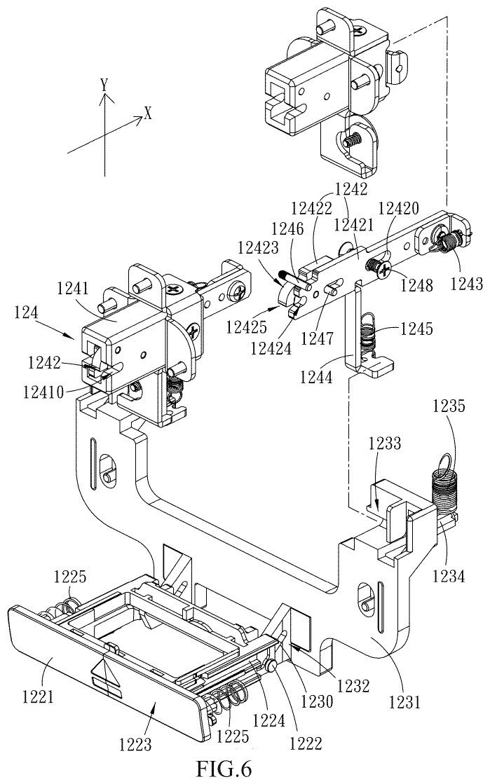

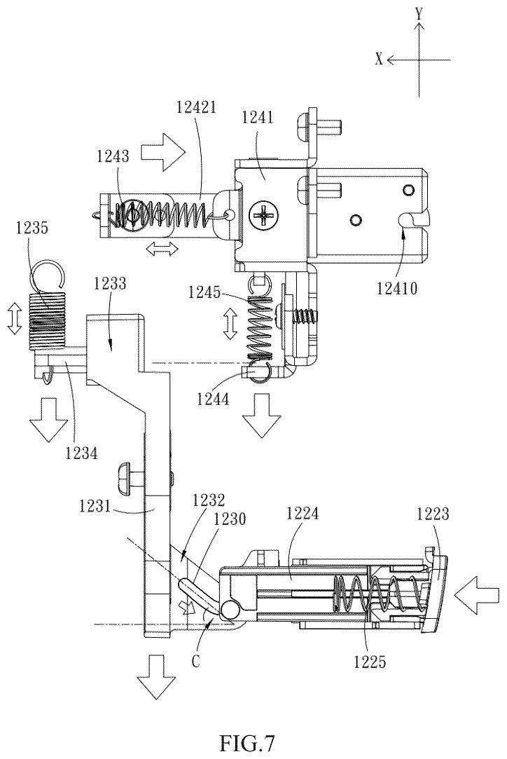

FIG. 6 is a partial exploded view of the press assembly, the connecting assembly and the locking assembly of the present application and FIG. 7 is a side view thereof. As shown in FIG. 6 and FIG. 7, in this embodiment, the press assembly 122 includes a press element 1221 and a guide post 1222, the press element 1221 has a press portion 1223 and two extension portions 1224. One end of each of the two extension portions 1224 extends from the press portion 1223 toward the interior of the case 121. The guide post 1222 is disposed at the one end of the extension portion 1224; i.e., the guide post 1222 is transversely is located at the one end of the extension portion 1224 and both ends of the guide post 1222 are fixed to the extension portion 1224. Additionally, the connecting assembly 123 includes a connection main body 1231. The connection main body 1231 has two pushing portions 1232. The two pushing portions 1232 extend from the connection main body 1231 toward the positions of the two extension portion 1224 of the press element 1221. The pushing portion 1232 has a slide hole 1230, the slide hole 1230 is a transverse opening corresponding to the guide post 122. The guide post 1222 at one end of the press element 1221 passing through the slide hole 1230 of the pushing portion 1232 and the guide post 1222 of the press element 1221 moves along the slide hole 123. The slide hole 1230 of the pushing portion 1232 forms an angle C relative to the movement direction of the press element 1221 toward the pushing portion 1232. In other word, when the extension portion 1224 of the press element 1221 moves along with the guide post 1222, because the guide post 1222 moves in a straight line, the guide post 1222 will press against the edge of the lower opening of the slide hole 1230. As a result, the pushing portion 1232 will be pressed downward due to the guide post 1222 pressing against the slide hole1230, causing the pushing portion1232 to move. Consequently, the pushing portion 1232 will move downward in conjunction with the connecting the connection main body1231.

Furthermore, the press assembly 122 includes a press elastic member 1225. The press elastic member 1225 is disposed between the press element 1221 and the surface of the case 121, wherein an elastic force direction of the press elastic member 1225 and the movement direction of the press element 1221 is the first axis X. In this embodiment, when the press element 1221 is pushed inward towards the case 121, the press element 1221 compresses the elastic force of the press elastic member 1225. When the press element 1221 is no longer subjected to external pressure, the restoring force of the press elastic member 1225 drives the press element 1221 back to its original position before being pressed.

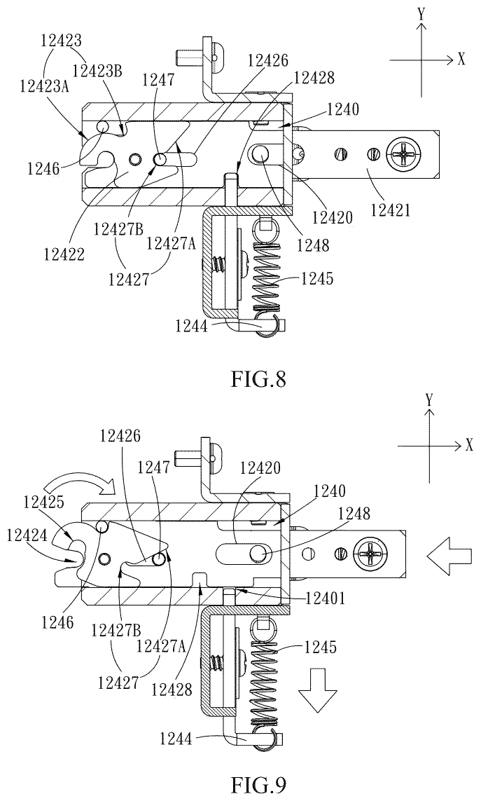

FIG. 8 is a schematic view of the locking assembly of the present application and FIG. 9 is a cross-sectional view of the locking assembly. Referring to FIG. 6, in this embodiment, the connection main body 1231 of the connecting assembly 123 further has a pressing element 1233. The locking assembly 124 includes a lock housing 1241, a lock unit 1242, a lock elastic element 1243, a lock pin 1244, and a lock pin elastic element 1245. The lock housing 1241 is disposed within the case 121. The lock unit 1242 extends through the lock housing 1241. One end of the lock unit 1242 extends through the case 121 into the accommodating groove 1211, and one end of the lock unit 1242 connects to the fixing assembly 111 fixed to the speaker11. One end of the lock elastic element 1243 connects to the lock housing 1241. Another end of the lock elastic element 1243 connects to another end of the lock unit 124. One end of the lock pin 1244 extends through the lock housing 1241 and one end of the lock pin 1244 is engaged with a side of the lock unit 1242. One end of the lock pin elastic element 1245 connects to the lock housing 1241. Another end of the lock pin elastic element 1245 connects to another side of the lock pin 1244. The lock pin elastic element 1245 drives the lock pin 1244 to abut against a side of the lock unit 1242. The pressing element 1233 of the connection main body 1231 corresponds to another end of the lock pin 1244 of the locking assembly 124, wherein, the pressing element 1233 moves in conjunction with another end of the lock pin 1244. The connection between the pressing element 1233 and the lock pin 1244 can be achieved through structural interlocking, adhesive bonding, or other assembly methods, which can be adjusted according to user requirements but are not limited to these methods.

Referring to FIG. 7, when the press element 1221 drives the connection main body 1231 to move downward, the pressing element 1233 pushes down on the other end of the lock pin 1244. This causes one end of the lock pin 1244 to move away from a side of the lock unit 1242, disengaging the lock pin 1244 from the side of the lock unit 1242. Consequently, the lock elastic element 1243 drives the lock unit 1242 to move, releasing the end of the lock unit 1242 from its connection and fixation with the assembly 111 of the speaker 11. The elastic force direction of the lock elastic element 1243 and the movement direction of the lock unit 1242 is the first axis X.

As described above, the lock housing 1241 includes a lock pin channel 1240 and a fixed through hole 12401. The fixed through hole 12401 locates on the surface of the lock housing 124 and the fixed through hole 12401 is communicating with the lock pin channel 124. The lock unit 1242 further includes a moving element 12421. A side of the moving element 12421 has a fixed notch 12428. The fixed through hole 12401 locates on the movement path of the fixed notch 12428 of the moving element 12421. One end of the lock pin 1244 passes though the fixed through hole 12401. One end of the lock pin 1244 is embedded within the fixed notch 12428 to allow one end of the lock pin 1244 to be engaged with a side of the lock unit 1242.

Moreover, the connection main body 1231 of the connecting assembly 123 further has an elastic fixing portion 1234. The connecting assembly 123 further has a connecting elastic portion 1235. One end of the connecting elastic portion 1235 connects to the elastic fixing portion 1234 and another end of the connecting elastic portion 1235 connects to the inner part of the case 121, please referring to FIG. 4. The elastic force direction of the connecting elastic portion 1235 and the direction in which the pressing element 1233 of the connection main body 1231 presses down the lock pin 131 is the second axis Y. In this embodiment, when the press element 1221 drives the connection main body 1231 to move downward, the elastic fixing portion 1234 of the connection main body 1231 stretches the elastic force of the connecting elastic portion 1235. When the connection main body 1231 is no longer driven downward by an external force, the elastic restoring force of the connecting elastic portion 1235 will drive the connection main body 1231 back to its original position. Additionally, the elastic force direction of the lock pin elastic element 1245 of the locking assembly 124 and the movement direction of the lock pin 1244 is the second axis Y. (see FIG. 9). In this embodiment, when pressing element 1233 drives the lock pin 1244 to move downward, the lock pin 1244 stretches the elastic force of the lock pin elastic element 1245. When the lock pin 1244 is no longer driven downward by an external force, the elastic restoring force of the lock pin elastic element 1245 will drive the lock pin1244 back to its original position.

Referring to FIG. 7, in this embodiment, the elastic force direction of the press elastic member 1225 and the pressing direction of the press element 1221 is the first axis X. The elastic force direction of the connecting elastic portion 1235 and the movement direction of the elastic fixing portion 1234 of the connection main body 1231 is the second axis Y. The elastic force direction of the lock pin elastic element 1245 and the movement direction of the lock pin 1244 is the second axis Y. The elastic force direction of the lock elastic element 1243 and the movement direction of the lock unit 1242 is the first axis X, the first axis X and the second axis Y are perpendicular to each other.

In this embodiment, referring to FIG. 8 and FIG. 9, the locking assembly 124 further includes a first guide member 1246. The lock housing 1241 includes a lock pin channel 1240. The first guide member 1246 extends through the lock housing 1241 and the first guide member 1246 locates within the lock pin channel 1240. The lock unit 1242 further includes a moving element 12421 and a hook element 12422. The hook element 12422 is rotatably disposed at one end of the moving element 12421. The first guide member 1246 locates on the movement path of the first side 12423 of the hook element 12422. When the moving element1 2421 moves in conjunction with the hook element 12422, the first guide member 1246 will move along the contour of the first side 12423 of the hook element 12422, causing the hook element 12422 to rotate relative to the moving element 12421.

As described above, one end of the moving element 12421 has a first concave 12424 and one end of the hook element 12422 has a second concave 12425 relative to the first concave 12424. The second concave 12425 rotates relative to the first concave 12424 to become closed or open. The first side 12423 of the hook element 12422 has arc edge 12423A and a first concave edge 12423B. The first concave edge 12423B and the arc edge 12423A are connected and extended side edges. When the arc edge 12423A of the hook element 12422 abuts against the first guide member 1246, the first concave 12424 and the second concave 12425 are relatively closed; when the first concave edge 12423B of the hook element 12422 abuts against the first guide member 1246, the first concave 12424 and the second concave 12425 are relatively open.

Furthermore, the locking assembly 124 further includes a second guide member 1247. The second guide member 1247 extends through the lock housing 1241. The second guide member 1247 locates within the lock pin channel 1240. The lock unit 1242 further includes a moving element 12421 and a hook element 12422. The hook element 12422 is rotatably disposed at one end of the moving element 12421. The moving element 12421 further has a moving hole 12426 and the second guide member 1247 locates within the moving hole 12426. The second guide member 1247 locates on the movement path of the second side 12427 of the hook element 12422. When the moving element 12421 moves in conjunction with the hook element 12422, the second guide member 1247 moves along the contour of the second side 12427 of the hook element 12422, causing the hook element 12422 to rotate relative to the moving element 12421.

As described above, the second side 12427 of the hook element 12422 has an inclined edge 12427A and a second concave edge 12427B. The second concave edge 12427B and the inclined edge 12427A are connected and extended side edges. When the second concave edge 12427B of the hook element 12422 abuts against the second guide member 1247, the first concave 12424 and the second concave 12425 are relatively closed; when the inclined edge 12427A of the hook element 12422 abuts against the second guide member 1247, the first concave 12424 and the second concave 12425 are relatively open.

In addition, the lock housing 1241 has an opening 12410 at one end of the housing adjacent to the first concave 12424 and the second concave 12425, referring to FIG. 4, the opening 12410 corresponds to the stationary post 1112 of the fixing assembly 111 of the speaker 11. When the stationary post 1112 is locked within the first concave 12424 and the second concave 12425, the stationary post 1112 is also fixed within the opening 12410 as an auxiliary fixing structure. Moreover, the locking assembly 124 further includes a position limiting element 1248. The position limiting element 1248 is disposed on the lock housing 1241. The position limiting element 1248 locates in the lock pin channel 1240. The lock unit 1242 further includes a moving element 12421 and the moving element 12421 further has a position limiting hole 12420. The position limiting element 1248 locates within the position limiting hole 12420, thereby restricting the movement of the position limiting hole 12420 of the moving element 12421 cannot move beyond the position set by the position limiting element 1248.

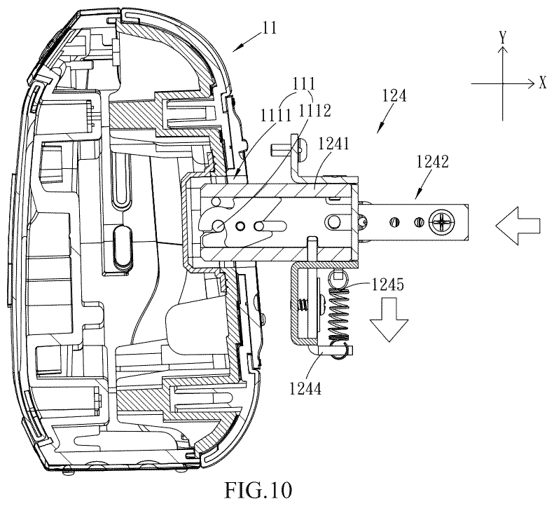

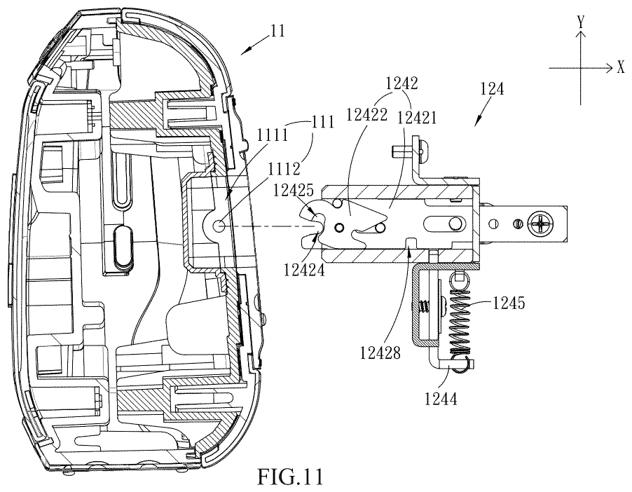

FIG. 10 is a schematic view of the combination of the locking assembly and the speaker and FIG. 11 is another schematic view of the combination of the locking assembly and the speaker. As shown in FIG. 10 and FIG. 11, in this embodiment, the fixing assembly 111 of the speaker 11 is engaged with the locking assembly 124, allowing the speaker 11 to be installed onto the base 12. To release the connection between the locking assembly 124 and the speaker 11, the pressing element 1233 pulls the lock pin1244 downwardly, and one end of the lock pin 1244 is moved away from one side of the lock unit 1242. Consequently, the lock pin 1244 is not engaged with the fixed notch 12428 of the lock unit 1242. The elastic restoring force of the lock elastic element 1243 drives the lock unit 1242 to move, and one end of the lock unit 1242 moves toward the direction of the speaker 11, causing the first concave 12424 of the moving element 12421 at one end of the lock unit 1242 and the second concave 12425 of the hook element 12422 to rotate relative to each other. Thus, the first concave 12424 and the second concave 12425 are relatively open, allowing the stationary post 1112 of the fixing assembly 111 of the speaker 11 to disengage from the locking assembly 124, thereby releasing the connection between the speaker 11 and the base 12.

Conversely, to fix the speaker 11 to the base 12, aligned the fixing assembly 111 of the speaker with the locking assembly 124 of the base 12, and then press the fixing assembly 111 of the speaker 11 into the locking assembly 124. Then the lock unit 1242 of the locking assembly 124 compresses the lock elastic element 1243, causing the fixed notch 12428 of the lock unit 1242 to align again with the fixed through hole 12401 of the lock housing 1241. The elastic restoring force of the lock pin elastic element 1245 drives lock pin 1244 to be embedded within the fixed notch 12428, engaging the lock pin 1244 with the lock unit 1242. At the same time, the first concave 12424 of the moving element 12421 at one end of lock unit 1242 and the second concave 12425 of the hook element 12422 will rotate relative to each other, causing the first concave 12424 and the second concave 12425 to be relatively closed. This allows the stationary post 1112 of the fixing assembly 111 of the speaker 11 to be fixed within the locking assembly 124, thereby fixing the connection between the speaker 11 and the base 12.

In summary, the present application provides a speaker structure that includes a speaker and a base. The speaker is locked to the base. The base fixes or unlocks the speaker by means of a mutual linkage of a press assembly, a connecting assembly and a locking assembly. The locking assembly of the base is used to fix the speaker. The press assembly is used to move in conjunction of the connecting assembly, and then the connecting assembly unlocks the speaker fixed by the locking assembly. This design allows the speaker to be easily detached from the base without taking too much time. In vehicle applications, the base of the speaker structure can be embedded and installed at an appropriate location within the vehicle body. For example, it can be fixedly installed on the flat area of the vehicle dashboard, embedded in the vehicle seat, or positioned in the central control area of the vehicle.

The above description illustrates and describes several preferred embodiments of the present invention. As mentioned earlier, it should be understood that the present invention is not limited to the forms disclosed herein and should not be considered as excluding other embodiments. It can be applied to various other combinations, modifications, and environments and can be adapted within the scope of the inventive concept as described herein through the teachings provided or knowledge and techniques of related fields. Modifications and variations made by those skilled in the art without departing from the spirit and scope of the present invention should be covered by the appended claims of the present invention.

1. A speaker structure, comprising:
a speaker having a fixing assembly; and
a base, comprising:
a case, a surface of the case having an accommodating groove and the speaker being configured to be installed within the accommodating groove; and
a locking assembly, comprising:
a lock housing disposed within the case;
a lock unit extending through the lock housing, one end of the lock unit extending through the case into the accommodating groove, and the one end of the lock unit connecting to the fixing assembly fixed to the speaker;
a lock elastic element, one end of the lock elastic element connecting to the lock housing and another end of the lock elastic element connecting to another end of the lock unit;
a lock pin, one end of the lock pin extending through the lock housing, one end of the lock pin extending through the lock housing, and the one end of the lock pin engaging with a side of the lock unit; and
a lock pin elastic element, one end of the lock pin elastic element connecting to the lock housing, another end of the lock pin elastic element connecting to another end of the lock pin, and the lock pin elastic element driving the lock pin to abut against the side of the lock unit,
wherein the one end of the lock pin is configured to move away from the side of the lock unit, the lock pin is not engaged with the side of the lock unit, and the lock elastic element drives the lock unit to move, for releasing a connection between the one end of the lock unit relative to the fixing assembly of the speaker.

2. The speaker structure as claimed in claim 1, wherein the locking assembly further comprises a first guide member,
wherein the lock housing comprises a lock pin channel,
wherein the first guide member extends through the lock housing,
wherein the first guide member is located within the lock pin channel,
wherein the lock unit further comprises a moving element and a hook element, the hook element being rotatably disposed at one end of the moving element, and
wherein the first guide member is located on a movement path of a first side of the hook element, and when the moving element moving in conjunction with the hook element, the first guide member moves along a contour of the first side of the hook element, causing the hook element to rotate relative to the moving element.

3. The speaker structure as claimed in claim 2, wherein the one end of the moving element has a first concave,
wherein the hook element has a second concave at the end corresponding to the first concave,
wherein the second concave rotates relative to the first concave to become closed or open, and
wherein the first side of the hook element has an arc edge and a first concave edge, the first concave edge and the arc edge are connected and extended side edges, when the arc edge of the hook element abuts against the first guide member, the first concave and the second concave are relative closed; when the first concave edge of the hook element abuts against the first guide member, the first concave and the second concave are relative open.

4. The speaker structure as claimed in claim 1, wherein the locking assembly further comprises a second guide member,
wherein the lock housing comprises a lock pin channel,
wherein the second guide member extends through the lock housing,
wherein the second guide member is located within the lock pin channel,
wherein the lock unit further comprises a moving element and a hook element, the hook element being rotatably disposed at one end of the moving element,
wherein the moving element further has a moving hole,
wherein the second guide member is located within the moving hole, and
wherein the second guide member is located on a movement path of a second side of the hook element, and when the moving element moves in conjunction with the hook element, the second guide member moves along a contour of the second side of the hook element, causing the hook element to rotate relative to the moving element.

5. The speaker structure as claimed in claim 4, wherein the one end of the moving element has a first concave,
wherein the hook element has a second concave at an end corresponding to the first concave, and the second concave is configured to rotate relative to the first concave to become closed or open,
wherein the second side of the hook element has an inclined edge and a second concave edge, the second concave edge and the inclined edge are connected and extended side edges, when the second concave edge of the hook element abuts against the second guide member, the first concave and the second concave are relative closed, and
wherein when the inclined edge of the hook element abuts against the second guide member, the first concave and the second concave are relative open.

6. The speaker structure as claimed in claim 1, wherein the locking assembly further comprises a position limiting element disposed in the lock housing,
wherein the position limiting element is located within the lock pin channel,
wherein the lock unit further comprises a moving element, and
wherein the moving element further comprises a position limiting hole, and the position limiting element is located within the position limiting hole.

7. The speaker structure as claimed in claim 1, wherein the lock housing comprises a lock pin channel and a fixed through hole located on a surface of the lock housing,
wherein the fixed through hole and the lock pin channel are configured to communicate with each other,
wherein the lock unit further comprises a moving element, one side of the moving element having a fixed notch, and
wherein the fixed through hole is located on the moving path of the fixed notch of the moving element, the one end of the lock pin passes through the fixed through hole, and the one end of the lock pin is embedded in the fixed notch, causing the one end of the lock pin to engage with the side of the lock unit.

8. The speaker structure as claimed in claim 1, wherein an elastic force direction of the lock elastic element and a movement direction of the lock unit is a first axis, the elastic force direction of the lock pin elastic element and the movement direction of the lock pin is a second axis, and the first axis and the second axis are perpendicular to each other.

9. The speaker structure as claimed in claim 1, wherein the base further comprises:
a press assembly, one end of the press assembly passing through the case; and
a connecting assembly disposed within the case,
wherein the one end of the press assembly moves in conjunction with the connecting assembly and the connecting assembly moves in conjunction with another end of the lock pin.

10. The speaker structure as claimed in claim 9, wherein the connecting assembly further comprises a connection main body, the connection main body of the connecting assembly comprising a pressing element corresponding to the another end of the lock pin of the locking assembly, and when the press assembly moves in conjunction with the pressing element of the connection main body, the pressing element moves in conjunction with the another end of the lock pin, causing the one end of the lock pin to move away from the side of the lock unit.

11. The speaker structure as claimed in claim 10, wherein the connecting assembly further comprises a connecting elastic portion, the connection main body of the connecting assembly further comprises an elastic fixing portion, one end of the connecting elastic portion connects to the elastic fixing portion, another end of the connecting elastic portion connects to an inner portion of the case, and an elastic force direction of the connecting elastic portion and a direction that the pressing element of the connection main body moves with the lock pin is a second axis.

12. The speaker structure as claimed in claim 1, wherein the fixing assembly comprises:
a recess; and
a stationary post,
wherein two ends of the stationary post are fixed to a recess inner wall of the recess and the one end of the lock unit is fixed to the stationary post within the recess.
